(19) United States
(12) Patent Application Publication
(10) Pub. No.: US 2019/0293179 A1
(43) Pub. Date: Sep. 26, 2019

(54) SEAL STRUCTURE, SEALING METHOD, AND COUPLING EQUIPPED WITH SAID SEAL STRUCTURE

(71) Applicant: FUJIKIN INCORPORATED, Osaka-shi (JP)

(72) Inventors: Koji Hiramatsu, Osaka-shi (JP); Michio Yamaji, Osaka-shi (JP); Kunihiko Daido, Osaka-shi (JP); Tadayuki Yakushijin, Osaka-shi (JP); Yasumasa Yanagida, Osaka-shi (JP); Takashi Funakoshi, Osaka-shi (JP)

(73) Assignee: FUJIKIN INCORPORATED, Osaka-shi (JP)

(21) Appl. No.: 16/345,258

(22) PCT Filed: Oct. 26, 2017
(86) PCT No.: PCT/JP2017/038599

§ 371 Date: Apr. 26, 2019

(30) Foreign Application Priority Data
Oct. 31, 2016 (JP) 2016-212816

(51) Int. Cl. F16J 15/08; F16L 23/032; F16L 23/16; F16K 27/02

(52) U.S. Cl. CPC F16J 15/08; F16L 23/032; F16J 15/10; F16K 27/0209; F16L 23/16

(57) ABSTRACT

Provided are a seal structure in which sealing performance is ensured over a long period of time even when it is used for low-temperature fluids, a sealing method, and a coupling including the seal structure. The seal structure includes an annular gasket interposed between a first member and a second member. The first member is provided on its surface facing the gasket with: an annular protrusion; an inclined surface located on an inner diameter side with respect to the annular protrusion and inclined in a direction away from the gasket; and an outer-diameter-side surface located on an outer diameter side with respect to the protrusion.

### TECHNICAL FIELD

The present invention relates to a seal structure used for a coupling or the like having a built-in check valve mechanism, a sealing method, and a coupling equipped with the seal structure.

### BACKGROUND ART

A well-known coupling includes: first and second coupling members respectively having fluid passages that are in communication with each other; a seal member (O-ring, gasket, or the like) placed at a butt portion of both coupling members; and a fastening means (nut or the like) for joining together the coupling members.

The greatest challenge for the coupling is improvement of its seal structure. Patent Literature 1 discloses a seal structure used for a high-pressure pipe joint, in which an annular gasket is provided and a coupling member is provided on a surface facing the gasket with: a small plane located on the inner diameter side and orthogonal to a fluid passage; and an inclined surface contiguous with the small plane and formed so as to be recessed with respect to the small plane.

Further, a known coupling, in some cases, has a built-in check valve mechanism including a plug body and a biasing member that urges the plug body, which is referred to as an inline type check valve or the like (Patent Literature 2). According to Patent Literature 2, a packing is interposed at a butt portion of a first member and a second member.

### CITATION LIST

### Patent Literature

Patent Literature 1: Japanese Unexamined Patent Application Publication JP-A-2016-14468

Patent Literature 2: Japanese Unexamined Patent Application Publication JP-A-2015-175518

### SUMMARY OF INVENTION

### Technical Problem

Couplings are used under various conditions where ensuring sealing performance is difficult, and one of such conditions is a low-temperature condition. In the case where the coupling is used under the low-temperature condition, deterioration of sealing performance due to contraction associated with temperature cycling is a matter of concern. In the check valve disclosed in Patent Literature 2, the packing used as a seal member has a seal performance problem when used for low-temperature fluids.

In addition, the seal structure disclosed in Patent Literature 1 has a sealing performance problem because: in the case where the seal structure is used during temperature cycling under a low-temperature condition, sealing performance by the small plane on the inner side decreases due to the contraction of the coupling members; and the inclined surface does not contribute to ensuring the sealing performance since the inclined surface has a smaller biting amount with respect to the gasket as compared to that of the small plane.

An object of the present invention is to provide a seal structure in which sealing performance is ensured over a long period of time even when it is used for low-temperature fluids, a sealing method, and a coupling equipped with the seal structure.

### Solution to Problem

The seal structure in accordance with the present invention is a seal structure provided at a butt portion of a first member and a second member respectively having fluid passages that are in communication with each other, the seal structure constituted by part of the first member and the second member, the seal structure comprising an annular gasket interposed between the first member and the second member, and at least one of the first member and the second member, which are coupling members, being provided on its surface facing the gasket with: an annular protrusion; an inclined surface located on an inner diameter side with respect to the annular protrusion and inclined in a direction away from the gasket; and an outer-diameter-side surface located on an outer diameter side with respect to the protrusion.

The first and second members may be fastened by an appropriate fastening means. The fastening means may be designed such that, for example, a male screw portion is formed on either one of the first and second coupling members, and the first and second coupling members are joined together with a cap nut on which the male screw portion of the coupling member is screwed. Alternatively, the fastening means may be designed such that the first and second coupling members are sleeves with no male screw portions formed, and the first and second coupling members are joined together with a male screw member, which is a separate member, and a cap nut. In addition, the first and second coupling members may be designed such that one of the coupling members is provided with a bolt insertion hole and the other of the coupling members is provided with a female screw portion whereby both members are joined together with a bolt.

The gasket generally has two side surfaces that are orthogonal to the central axis of the gasket, is rectangular in cross section, and consists of: according to needs, for example, a large diameter portion; and a small diameter portion having an inner diameter equal to that of the large diameter portion and having an outer diameter smaller than that of the large diameter portion. Each of the side surfaces of the gasket may be an inclined surface having an inclination angle smaller than an inclination angle of the inclined surface of the coupling member, with respect to a surface orthogonal to the fluid passage. In addition, the gasket may be provided with an annular recessed portion corresponding to the protrusion of the coupling member.

An outer-diameter-side end portion of the inclined surface located on the inner diameter side of the annular protrusion is preferably designed so as to come into contact with the protrusion having the shape of a circular arc in cross section. The outer-diameter-side surface of the gasket-facing surface of the coupling member is, for example, a surface orthogonal to the fluid passage (axis of the gasket), but may be an inclined surface. In the case of the inclined surface, the outer-diameter-side surface may be an inclined surface gradually protruding with respect to a surface orthogonal to the fluid coupling from the inner diameter side toward the outer diameter side, or may be an inclined surface gradually recessed with respect to the surface orthogonal to the fluid pas sage from the inner diameter side toward the outer diameter side.

A plane orthogonal to an axis of the gasket is preferably formed on a further inner diameter side of the inclined surface. This plane is not a portion contributing to sealing. A gap between this plane and the gasket may not be formed, or a slight amount of a gap may be formed therebetween.

The first and second members are, for example, made of stainless steel such as SUS 316 whereas the gasket is made of metal such as a nickel alloy and stainless steel, but they are not limited thereto.

The protrusion has the shape of, for example, a circular arc in cross section, but may be a trapezoid, or any other shape in cross section.

Surfaces that face the gasket, of the first and second members may be identical to each other. Alternatively, only either one of the surfaces may be shaped as described above whereas the other one may be a flat surface orthogonal to the fluid passage.

The sealing method in accordance with the present invention is a sealing method at a time of fastening a screw to connect a first member and a second member respectively having fluid passages that are in communication with each other, the sealing method comprising the steps of, interposing an annular gasket between the first member and the second member, and providing at least one of the first member and the second member on its surface facing the gasket with: an annular protrusion; an inclined surface located on an inner diameter side with respect to the annular protrusion and inclined in a direction away from the gasket; and an outer-diameter-side surface located on an outer diameter side with respect to the protrusion, and associated with the tightening of the screw, first bringing the protrusion into contact with a side surface of the gasket, and then bringing the inclined surface, from a portion closer to the protrusion, into contact with the side surface of the gasket.

In the seal structure and the sealing method in accordance with the present invention, in the case where a low-temperature fluid is caused to flow through the fluid passage, the portion closer to the fluid passage of the coupling member, and a part of the gasket corresponding to that portion contract. Therefore, in a case where the seal structure is repeatedly subjected to temperature cycling under a low-temperature condition, decrease in sealing performance at the portion closer to the fluid passage of the coupling member becomes a matter of concern. With the seal structure and the sealing method in accordance with the present invention, even in the case where the seal structure is used during temperature cycling under a low-temperature condition whereby sealing performance at the inner-diameter-side portion of the inclined surface is decreased, because the outer-diameter-side portion of the inclined surface has a greater biting amount with respect to the gasket compared to the inner-diameter-side portion of the inclined surface, sealing performance is ensured even in the case where the seal structure is thereafter subjected to temperature cycling under the low-temperature condition. Moreover, because the protrusion has a greater biting amount with respect to the gasket compared to the inclined surface, even in the case where the seal structure continues to be subjected to temperature cycling under the low-temperature condition after the decrease in sealing performance at the inner-diameter-side portion of the inclined surface, sealing performance is maintained over a long period of time.

The coupling in accordance with the present invention is a coupling including: a first member and a second member respectively having fluid passages that are in communication with each other; a fastening means configured to join together the first member and the second member; and a seal structure provided at a butt portion of the first member and the second member, the seal structure being one as described above.

With the coupling in accordance with the present invention, excellent long-term sealing performance is obtained at the time of use during temperature cycling under a low-temperature condition. The coupling is, for example, a pipe joint, but is not limited thereto. The coupling has a built-in check valve mechanism, in some cases.

The check valve mechanism has a plug body and a biasing member that urges the plug body. The check valve mechanism is configured such that: the plug body urged by the biasing member comes into contact with a face to be sealed whereby an opening of the fluid passage of one of the first and second members are in a shutoff state; whereas when a fluid pressure greater than or equal to a predetermined value is applied within the fluid passage, the plug body moves against a biasing force of the biasing member whereby an open state is obtained.

By applying the above-described seal structure to a coupling including a check valve mechanism, excellent long-term sealing performance of the check valve is obtained at the time of use during temperature cycling under a low-temperature condition.

### Advantageous Effects of Invention

With the seal structure, the sealing method, and the coupling in accordance with the present invention, even in the case where the coupling is used during temperature cycling under a low-temperature condition whereby sealing performance at the inner-diameter-side portion is decreased, sealing performance is ensured because both of the inner-diameter-side surface and the outer-diameter-side surface are in close contact with the gasket. Moreover, because the protrusion has a great biting amount with respect to the gasket, this contributes to ensuring sealing performance even further, and even when the coupling continues to be subjected to temperature cycling under the low-temperature condition, sealing performance is maintained over a long period of time.

### BRIEF DESCRIPTION OF DRAWINGS

FIG. 1 is a longitudinal sectional view showing a seal structure, a sealing method, and a coupling equipped with the seal structure, according to one embodiment of the present invention.

FIG. 2 is an enlarged longitudinal sectional view showing the principal components of the seal structure, which shows a state in which a nut is fastened by fingers.

### REFERENCE SIGNS LIST

1: coupling
2: first coupling member (first member)
3: second coupling member (second member)
4: fluid passage
5: fluid passage
6: gasket
7: nut
11: check valve mechanism
41: outer-diameter-side surface
42: protrusion
43: inclined surface
44: inner-diameter-side surface

### DESCRIPTION OF EMBODIMENTS

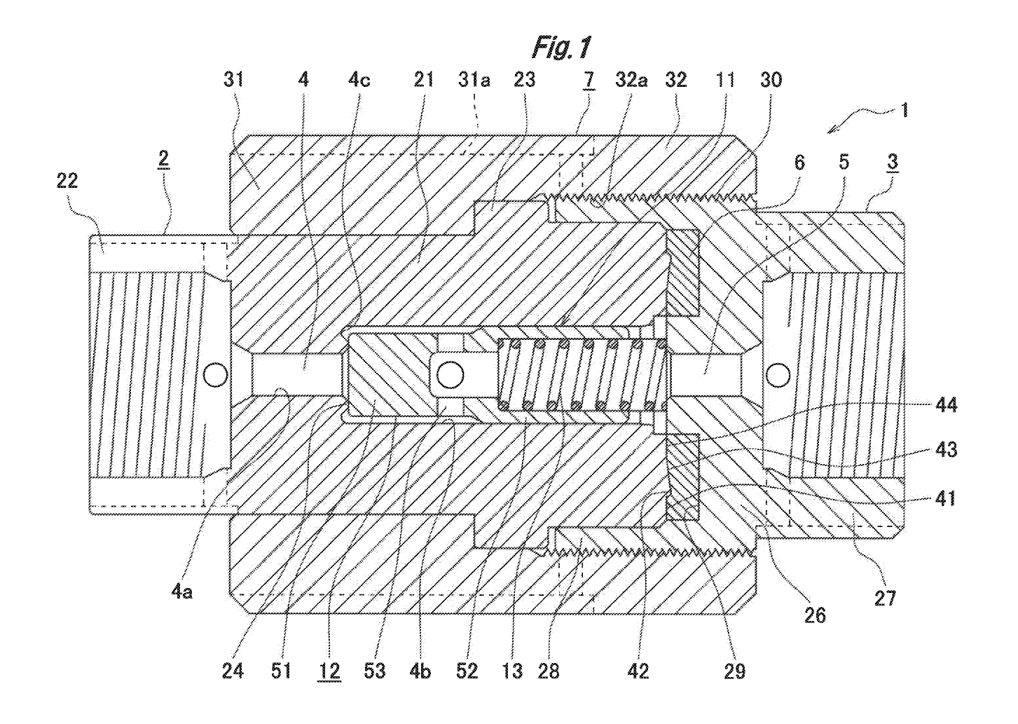

Embodiments of the present invention will be described below with reference to the drawings. In the following description, the left and right sides of FIG. 1 are referred to as left and right sides, respectively.

FIG. 1 shows a coupling 1 having a built-in check valve mechanism 11.

The coupling 1 includes: first and second coupling members 2, 3 respectively having fluid passages 4, 5 that are in communication with each other; an annular gasket 6 placed at a butt portion of the first coupling member 2 and the second coupling member 3; and a cap nut 7 for fastening the first coupling member 2 and the second coupling member 3.

The check valve mechanism 11 includes: a plug body 12 disposed in the first coupling member 2; and a biasing member 13 for urging the plug body 12.

The first coupling member 2 includes: a body 21; a female screw portion 22 used for pipe connection and provided at a left end of the body 21; and a flange portion 23 provided on an outer periphery, at a right portion, of the body 21.

The fluid passage 4 of the first coupling member 2 consists of: a small diameter portion 4a that is in communication with the female screw portion 22 via a tapered portion provided at the left end; and a large diameter portion 4b that is contiguous with the right side of the small diameter portion 4a via a stepped portion 4c. The stepped portion 4c is provided with an annular protrusion (seat) 24 receiving a left end surface of the plug body 12.

The second coupling member 3 includes: a body 26; a female screw portion 27 used for pipe connection and provided at a right end of the body 26; and a leftward protruding portion 28 provided at an outer peripheral portion of a left surface of the body 26.

The fluid passage 5 of the second coupling member 3 is in communication with an inside of the female screw portion 27 via a tapered portion provided at the right end. The body 26 of the second coupling member 3 is provided on a left surface thereof with a recess 29 for accommodating the gasket 6.

The gasket 6 has an effect of providing sealing performance by plastic deformation, has a platelike shape having a square cross section, and is accommodated in the recess 29 of the body 26 of the second coupling member 3.

The body 26 and the leftward protruding portion 28 of the second coupling member 3 are provided, on the outer periphery, with a male screw portion 30. The male screw portion 30 is formed so as to protrude radially outward slightly more than an outer peripheral surface of the flange portion 23 of the first coupling member 2.

The cap nut 7 includes: a small diameter portion 31 having an inner diameter that is slightly greater than an outer diameter of the body 21 of the first coupling member 2; and a large diameter portion 32 having an outer diameter that is equal to that of the small diameter portion 31 and having an inner diameter that is slightly greater than that of the flange portion 23 of the first coupling member 2. The large diameter portion 32 is provided on an inner periphery thereof with a female screw portion 32a. The small diameter portion 31 and part of the large diameter portion 32 contiguous with the small diameter portion 31 are provided with a hexagonal prism portion 31a with which a fastening tool such as a spanner is engaged.

The cap nut 7 is fitted on the first coupling member 2 from the left side, and the female screw portion 32a of the cap nut 7 is screwed on the male screw portion 30 of the second coupling member 3. And the right surface (stepped portion formed between the small diameter portion 31 and the large diameter portion 32) of the small diameter portion 31 comes into contact with the flange portion 23 of the first coupling member 2 whereby the small diameter portion 31 is prevented from moving further in the right direction. In this state, the cap nut 7 is fastened with a fastening tool by a predetermined amount whereby the first coupling member 2 and the second coupling member 3 are properly joined together.

At this time, the right end surface of the first coupling member 2 is pressed against the gasket 6 to plastically deform the gasket 6 whereby a required sealing performance are secured between the first coupling member 2 and the second coupling member 3.

The plug body 12 consists of: a columnar portion 51 by which a fluid escape passage 53 serving as a fluid passage in an open state is formed; and a large-diameter tubular portion 52 being contiguous with the right side (base end side) of the columnar portion 51 and having an outer diameter that is greater than that of the columnar portion 51.

When the left surface of the columnar portion 51 of the plug body 12 is brought into contact with a distal end of the annular protrusion 24 of the first coupling member 2, the plug body 12 causes a right end opening of the fluid passage 4 of the first coupling member 2 to be in a shutoff state.

The fluid escape passage 53 of the columnar portion 51 is formed so as to lead a fluid around an outer peripheral surface of the columnar portion 51 to an inside of the large-diameter tubular portion 52.

The biasing member 13 is a tubular compression coil spring, which has a left end surface that is received by the right surface of the columnar portion 51 of the plug body 12, and a right end surface that is received by the left surface of the body 26 of the second coupling member 3.

With this check valve mechanism 11, in the state shown in FIG. 1, the left surface of the columnar portion 51 of the plug body 12 that is urged by the biasing member 13 comes into contact with the annular protrusion 24 of the first coupling member 2 from the right whereby the shutoff state is obtained. A fluid is introduced into the small diameter portion 4a of the fluid passage 4 of the first coupling member 2. During a period in which the pressure of this fluid is less than the biasing force by the biasing member 13, the shutoff state is maintained. And when the fluid pressure becomes great, the plug body 12 moves rightward against the biasing force of the biasing member 13 due to the increased fluid pressure, which forms a passage running from an opening of the small diameter portion 4a of the fluid passage 4 of the first coupling member 2 through an outer periphery of the columnar portion 51 of the plug body 12, then running from the fluid escape passage 53 of the columnar portion 51 of the plug body 12 through an inside of the large-diameter tubular portion 52, and leading to an inside of the fluid passage 5 of the second coupling member 3, whereby an open state is obtained.

The first coupling member 2 is provided on its right end face with: an outer-diameter-side surface 41; an annular protrusion 42 located on the inner diameter side of the outer-diameter-side surface 41; an inclined surface 43 contiguous with the inner diameter side of the annular protrusion 42; and an inner-diameter-side surface 44 located on the inner diameter side of the inclined surface 43.

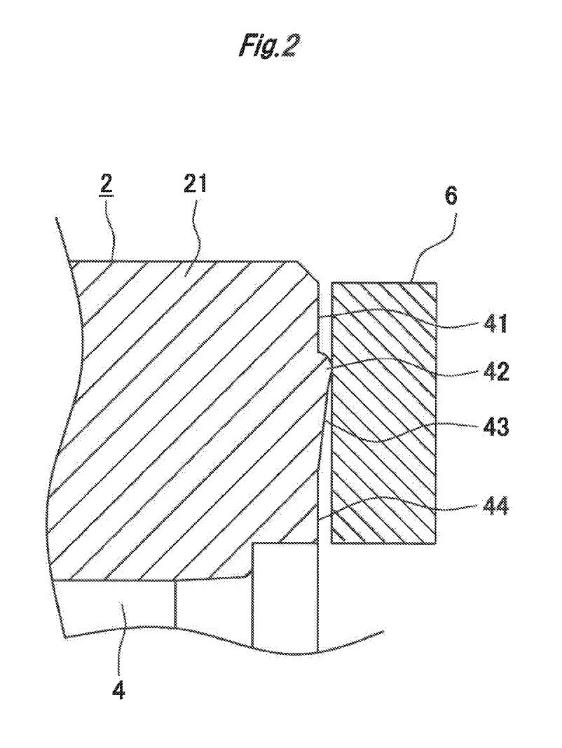

As shown in FIG. 2 in an enlarged manner, the outer-diameter-side surface 41 is a plane orthogonal to the fluid passage 4 (axis of the gasket 6). The inclined surface 43 is configured so as to be inclined in a direction away from the gasket 6 as the inclined surface 43 goes away from the protrusion 42. The inner-diameter-side surface 44 is a plane orthogonal to the fluid passage 4 (axis of the gasket 6).

The shape of the cross section of the protrusion 42 is an arc of a circle with a radius of 0.5 mm. The protrusion 42 protrudes with respect to the outer-diameter-side surface 41 by 0.04 mm. An outer-diameter-side end portion of the inclined surface 43 is designed so as to come into contact with the protrusion 42.

FIG. 1 shows a fastening completion state in which the cap nut 7 is fastened with a fastening tool by a predetermined amount, where the protrusion 42 digs into the gasket 6 and an entire surface of the inclined surface 43 is in close contact with the gasket 6. FIG. 2 shows a state in which the cap nut 7 is fastened by fingers, where only the protrusion 42 comes into close contact with the gasket 6.

The inner-diameter-side surface 44 is not a portion contributing to sealing. In a fastened state shown in FIG. 1, the gap between the inner-diameter-side surface 44 and the gasket 6 may not be formed, or a slight amount of a gap may be formed therebetween.

It should be noted that, in FIG. 1 and FIG. 2, the dimensions of the outer-diameter-side surface 41, the protrusion 42, the inclined surface 43, and the inner-diameter-side surface 44 are shown in an exaggerated manner for the sake of clarity.

With the above-described coupling 1, in the case of fastening the cap nut 7, first, the cap nut 7 is fastened by fingers, whereby the protrusion 42 comes into contact with a side surface of the gasket 6. Thereafter, when the cap nut 7 is fastened using a tool, the protrusion 42 starts digging into the side surface of the gasket 6, and the outer-diameter-side portion of the inclined surface 43, which is contiguous with the protrusion 42, comes into contact with the side surface of the gasket 6. When the cap nut 7 is further fastened, the protrusion 42 and the outer-diameter-side portion of the inclined surface 43 start digging into the side surface of the gasket 6. Thereafter, when the cap nut 7 is further fastened, the innermost-diameter-side portion of the inclined surface 43 comes into contact with the side surface of the gasket 6. The fastening amount is set so as to fasten the cap nut 7 until the innermost-diameter side-portion of the inclined surface 43 comes into contact with the side surface of the gasket 6, and in such a state, fastening is completed.

In the above-described state, the protruding amount of the protrusion 42 from the right end surface of the first coupling member 2, the degree of inclination of the outer-diameter-side surface 41, the inclined surface 43, and the inner-diameter-side surface 44, and the relative recessed amounts thereof with respect to one another may be variously modified within a range in which a condition that the protrusion 42 and the inclined surface 43, in this order, sequentially come into contact with the gasket 6 is satisfied.

### INDUSTRIAL APPLICABILITY

Using the seal structure, the sealing method, and the coupling in accordance with the present invention improves sealing performance under a low-temperature condition, thereby contributing to the safety during use of low-temperature fluids.

1. A seal structure provided at a butt portion of a first member and a second member respectively having fluid passages that are in communication with each other, the seal structure constituted by part of the first member and the second member,
the seal structure comprising an annular gasket interposed between the first member and the second member, and at least one of the first member and the second member, which are coupling members, being provided on its surface facing the gasket with: an annular protrusion; an inclined surface located on an inner diameter side with respect to the annular protrusion and inclined in a direction away from the gasket; and an outer-diameter-side surface located on an outer diameter side with respect to the protrusion.

2. The seal structure according to claim 1, wherein a plane orthogonal to an axis of the gasket is formed on a further inner diameter side of the inclined surface.

3. A sealing method at a time of fastening a screw to connect a first member and a second member respectively having fluid passages that are in communication with each other, the sealing method comprising the steps of, interposing an annular gasket between the first member and the second member, and providing at least one of the first member and the second member on its surface facing the gasket with: an annular protrusion; an inclined surface located on an inner diameter side with respect to the annular protrusion and inclined in a direction away from the gasket; and an outer-diameter-side surface located on an outer diameter side with respect to the protrusion, and
associated with the tightening of the screw, first bringing the protrusion into contact with a side surface of the gasket, and then bringing the inclined surface, from a portion closer to the protrusion, into contact with the side surface of the gasket.

4. A coupling comprising: a first member and a second member respectively having fluid passages that are in communication with each other; a fastening means configured to join together the first member and the second member; and a seal structure provided at a butt portion of the first member and the second member, the seal structure being the seal structure according to claim 1.

5. The coupling according to claim 4 having a built-in check valve mechanism.

6. A coupling comprising: a first member and a second member respectively having fluid passages that are in communication with each other; a fastening means configured to join together the first member and the second member; and a seal structure provided at a butt portion of the first member and the second member, the seal structure being the seal structure according to claim 2.

7. The coupling according to claim 6 having a built-in check valve mechanism.
